(19) United States
(12) Patent Application Publication
(10) Pub. No.: US 2021/0070545 A1
(43) Pub. Date: Mar. 11, 2021

(54) BANK NOTE CONTAINER PROVISION SYSTEM

(71) Applicant: GIESECKE+DEVRIENT CURRENCY TECHNOLOGY GMBH, Munchen (DE)

(72) Inventors: Andreas JAKOBS, Munchen (DE); Michael KNICKREHM, Augsburg (DE); Wolfgang KONIGER, Karlsfeld (DE)

(21) Appl. No.: 16/628,185

(22) PCT Filed: Jun. 29, 2018
(86) PCT No.: PCT/EP2018/000332

§ 371 Date: Jan. 2, 2020

(30) Foreign Application Priority Data
Jul. 3, 2017 (DE) 10 2017 006 280.3

(51) Int. Cl. B65G 1/02; B65H 31/30; B65G 13/11; B65G 21/12; B65G 47/88; B65G 43/00; B65G 61/00

(52) U.S. Cl. CPC B65G 1/023; B65H 31/3063; B65G 13/11; B65G 21/12; G07D 11/125; B65G 43/00; B65G 61/00; B65H 2301/42254; B65G 47/8823

(57) ABSTRACT

An apparatus is provided for receiving, temporarily storing and dispensing bank note containers as well as to a transport apparatus dockable thereto. The present invention further relates to a system arrangement comprising the proposed apparatus as well as the proposed transport apparatus. Further, a method arranged for operating the system arrangement is proposed as well as a computer program product having control commands executing the proposed method or operating the proposed system arrangement.

The present invention relates to an apparatus for receiving, temporarily storing and dispensing bank note containers as well as to a transport apparatus dockable thereto. The present invention further relates to a system arrangement comprising the proposed apparatus as well as the proposed transport apparatus. Further, a method arranged for operating the system arrangement is proposed as well as a computer program product having control commands executing the proposed method or operating the proposed system arrangement.

DE 10 2009 042 891 A1 shows containers for processing bank notes and a corresponding apparatus for processing bank notes.

DE 44 377 22 A1 shows a temporary storing of bank notes by means of a transport path, comprising a buffer path. The bank notes are led into the buffer path with the aid of a usual gate and guided back into the main transport system as soon as the stacker is ready for operation again.

DE 60 309 952 T2 shows an ATM for depositing and withdrawing bank notes, comprising a bank note temporary storage.

It is known to process bank notes in such a way that they are supplied by means of bank note containers and manually fed to corresponding machines. Here, according to the prior art, it is necessary that staff members, who have to be available, transport the bank note containers by means of for example a grid cart and then the corresponding bank note containers are manually carried to a machine. Here, it is particularly disadvantageous that the bank note containers have to be lifted manually by an assistant. This results in complex processing processes and staff has to be made available accordingly. In addition, such processes are prone to errors and there is a general need for apparatuses which simplify the transport of bank note containers.

It is also known to arrange a corresponding buffer in apparatuses processing bank notes. If for example there are not enough bank notes available on a machine processing bank notes, this results in idling which in turn can cause problems in the further processing chain. That means, it is known to hold ready the corresponding bank notes in a physical temporary storage which may vary with respect to its fill level. Thus, it is ensured that the processing machine has always available enough bank notes.

It is further known from the prior art that prior to the delivery of manufactured bank notes these must be packed in bundles, for the purpose of which corresponding receptacles and grid carts are supplied. Further, bank notes which are coming in from circulation must be re-sorted and checked accordingly. For this, too, there are semi-automated processing lines which typically comprise several workstations.

In known solutions it is particularly disadvantageous that complex processing processes arise due to the fact that bank note containers have to be transported manually or at least have to be removed manually from a corresponding transport apparatus. There is thus a need for corresponding apparatuses which furnish workstations or processing machines with bank notes with little technical effort.

It is therefore an object of the present invention to provide an apparatus for receiving, temporarily storing and dispensing bank note containers. Here, a mechanism is to be created which supports a machine or else a human operator in such a way that the bank notes or the bank note containers can be made available with only a minimum of effort. It is further an object of the present invention to provide a transport apparatus which is combinable with the proposed apparatus. Further, a corresponding system arrangement is to be provided which combines the proposed apparatus and the transport apparatus. Further, it is an object of the present invention to provide a method for operating the apparatuses or the system arrangement, as well as a computer program product having control commands which implement the proposed method.

The object is achieved by the features of claim 1. Further advantageous configurations are stated in the subclaims.

Accordingly, an apparatus for receiving, temporarily storing and dispensing bank note containers is proposed, comprising at least two buffer paths configured to be elongated and arranged for temporarily storing a plurality of bank note containers within the apparatus, wherein the at least two buffer paths are each movable, in particular tiltable, independently of each other into a first position for receiving bank note containers and are further movable, in particular tiltable, independently of each another into a second position for dispensing bank note containers.

The proposed apparatus is arranged in such a way that it comprises at least one device for receiving and/or dispensing bank note containers. This may be for example an opening into which the bank note container is inserted or through which bank note containers are dispensed. It is particularly preferred here that rollers are arranged in the apparatus, for example at the buffer paths, which effectuate that the bank note containers can be introduced into the apparatus or removed therefrom in a rolling manner. Here, corresponding apparatuses or devices for receiving and/or dispensing can be configured in such a way that these are combinable with other apparatuses in such a way that the bank note containers can be rolled into or out of another machine or the transport apparatus according to the invention in such a way. Thus, according to the invention, it is no longer necessary for a staff member to lift the bank note containers and insert these into another apparatus. It is possible here that further devices for receiving or dispensing bank note containers are made available.

The temporarily storing of bank note containers is effected according to the proposed apparatus in such a way that buffer paths are provided which can accommodate the bank note containers. It is particularly preferred here that at least two buffer paths configured in an elongated manner are provided, as the plurality of bank note containers may comprise empty bank note containers as well as filled bank note containers. Thus, there can be provided a first buffer path which saves empty bank note containers and a second buffer path which saves filled bank note containers. Temporary storing or saving is generally a safekeeping of bank note containers within the apparatus according to the invention. Thus, the proposed apparatus can serve as a buffer which comprises at least two buffer paths on which the bank note containers are placed. Here, the person skilled in the art recognizes that the bank note containers can be brought in any manner into the buffer paths in such a way that the bank note containers are at least temporarily attached to the buffer path. It is advantageous here that the bank note containers can be moved on the buffer path within the proposed apparatus. For example, a gradient can be arranged on the buffer paths, which ensures that the bank note containers always roll or are moved into a desired position.

In general, the buffer paths within the apparatus can be configured in the same way, it being particularly preferred that at least one buffer path is provided for empty bank note containers and at least one second buffer path for filled bank note containers. Within the context of the present invention, a filled bank note container is understood to be a bank note container that is at least partially filled with bank notes, the corresponding bank notes being arranged in singled manner or in bundles within the bank note container. Thus, also conventional bank note containers are suitable for being used in the proposed apparatus.

In general, the two buffer paths are tiltable independently of each other, it being advantageous to tilt at least one first buffer path in such a way that bank note containers can be received and to tilt at least one second buffer path in such a way that bank note containers can be dispensed. It is generally possible to tilt a buffer path in such a way that the bank note containers move out of the proposed apparatus on one side. However, if a buffer path is tilted in the inverse direction, it is possible that the bank note containers may slide into the proposed apparatus. Thus, it is possible to define, by means of an adjusted slope which is adjusted by means of tilting, the direction in which the bank note containers move within the proposed apparatus. In this connection, further locking means are provided which can lock the bank note containers within the apparatus or limit the buffer paths in such a way that the bank note containers do not fall out of the proposed apparatus. It is also possible according to the invention to provide a third position of the buffer paths, which is horizontal such that the bank note containers do not move within the proposed apparatus. Thus, a first and a second position are not to be understood as exhaustive, but rather the person skilled in the art recognizes that these are at least two positions which are also variable regarding their slope.

The proposed tilting or the tiltable configuration is the adjustment of a slope of the buffer paths. Here, it is advantageous to mutually coordinate the buffer paths, it being also possible, independently thereof, to move the buffer paths separately from each other. It is particularly advantageous to arrange at least a first buffer path with a rising direction and another buffer path with a falling direction. It is thus ensured that bank note containers can slide into the proposed apparatus as well as can slide out of it. By means of the slope to be adjusted, also the position can be selected at which the bank note containers can be guided out of the apparatus or can be guided into the apparatus. The person skilled in the art recognizes that further apparatuses are to be provided which guide the bank note containers on the buffer path in such a way that they leave the proposed apparatus or are introduced into it in a suitable manner. Even if the number of bank note containers is not generally limited or is only limited by the spatial dimensions of the apparatus, a number of three to ten bank note containers per buffer path can be temporarily stored, for example. Temporarily storing refers here to the safekeeping of the bank note containers, as these are not processed in the proposed apparatus itself, but in separate machines to which the bank note containers are to be fed. Accordingly, further components may also be provided, such as for example the proposed transport apparatus which brings the bank note containers into the proposed apparatus.

According to one aspect of the present invention, the at least two buffer paths are to be filled or emptied independently of each other in such a way that at least one first buffer path is to be filled with empty bank note containers and at least one second buffer path with filled bank note containers is to be emptied. This has the advantage that filled bank note containers can be supplied to connected machines and empty bank note containers can be discharged. For example, a connected machine is a sorting machine which is furnished with bank notes by means of the proposed apparatus. Thus, full bank note containers can be fed to this sorting machine, and the corresponding empty bank note containers can be transported away.

According to another aspect of the present invention, the buffer paths are arranged one above the other. This has the advantage that on one side of the proposed apparatus bank note containers can be taken as well as inserted. Thus, the bank note containers are kept safe within the proposed apparatus in a space-saving manner and can be inserted or removed simultaneously.

According to another aspect of the present invention, the buffer paths are mounted to be tiltable in such a way that by means of an arising inclination the bank note containers are movable in a self-acting manner within the apparatus by means of gravity. This has the advantage that no further apparatuses are to be provided for moving the bank note containers, unless it is specified by means of the adjusted slope in which direction the bank note containers move and how fast. By means of the adjusted inclination, also the respective output point or input point of the bank note containers can be varied. Thus, the proposed apparatus can be variably docked to an existing machine.

According to another aspect of the present invention, the buffer paths have rollers for moving the bank note containers. This has the advantage that the bank note containers can also be moved already at a low inclination without the need for additional motors. This means that conventional bank note containers present in the form of a box can also be reused. Such a box can then be moved on the rollers within the proposed apparatus along the buffer paths configured in elongated manner.

According to another aspect of the present invention, the buffer paths have locking pawls for locking the bank note containers and/or for locking the position of the buffer paths. This has the advantage that simple devices are created by means of which it is ensured that the bank note containers do not fall out of the apparatus or that the inclination of the buffer paths is stably held and thus the corresponding buffer paths are firmly held in their position.

According to another aspect of the present invention, the buffer paths are conveyable from the first position into the second position by means of spring force and/or gravity. This has the advantage that no further motors need to be provided which vary the buffer paths in their position. For example, it is possible that the buffer paths are returned from the second position to the first position or vice versa by the action of human force. It is thus possible to build in, for example, a coil spring in such a way that the position is changed when the lock is released.

According to another aspect of the present invention, the buffer paths are secured by means of a cover against unauthorized intervention. This has the advantage that the buffer paths are physically covered in such a way that employees of the corresponding production lines do not get access to the bank note containers or to the bank notes themselves.

According to another aspect of the present invention, at least one transfer device for receiving and/or dispensing the plurality of bank note containers into and/or out of the apparatus is provided. This has the advantage that a quasi interface is created at the apparatus, which is arranged to receive the bank note containers in the apparatus or to dispense them from the apparatus. This can be, for example, an intervention or else a conveying of the bank note containers in such a way that the bank note containers can no longer be removed manually from the apparatus, but rather, for example, can be brought into the apparatus or can be moved out of the apparatus by means of a rolling surface.

The object is also achieved by a transport apparatus for filling and/or emptying the proposed apparatus, the transport apparatus cooperating with the apparatus in such a way that a plurality of bank note containers is exchangeable between the transport apparatus and the apparatus.

According to the invention, the transport apparatus is suitable to be coupled to the proposed apparatus by means of, for example, the transfer device. It is advantageous here that the transport apparatus itself is movable and can thus be brought toward the proposed apparatus with full and empty bank note containers and can be docked thereto. Thus, the transport apparatus is suitable for transporting the bank note containers toward or away from the proposed apparatus. Here, the transport apparatus has, among other things, the same features as the proposed apparatus, so that the buffer paths within the transport apparatus can be referred to as transport paths, the buffer paths being combinable with the transport paths. Thus, the bank note containers are brought from the transport apparatus into the apparatus and are temporarily stored therein. It is further possible to guide corresponding bank note containers out from the proposed apparatus and bring them into the transport apparatus. Thus, the transport apparatus is suitable, for example, for receiving bank note containers from a vehicle and for bringing them toward the proposed apparatus. The proposed apparatus is typically configured to be stationary with respect to location and the transport apparatus is configured to be variable with respect to location. For example, the transport apparatus may comprise rollers which keep the transport apparatus movable.

The object is also achieved by a system arrangement for the mechanical supplying of a plurality of bank note containers, comprising the proposed apparatus as well as the transport apparatus. It is thus particularly advantageous that the system arrangement comprises at least one of the proposed apparatuses and at least one transport apparatus. Thus, the proposed apparatus and the proposed transport apparatus form an overall system by means of which bank note containers can be received, temporarily stored and dispensed.

According to one aspect of the present invention, further processing machines are provided to which bank note containers are fed or from which bank note containers are taken by means of the apparatus. This has the advantage that the proposed system arrangement can act as a buffer system which supplies bank note containers to further machines or transports away several bank note containers.

According to another aspect of the present invention, the system arrangement can be operated at least partly in an automated manner. This has the advantage that, for example, the conveying of the bank note containers between the apparatus and the transport apparatus can be effected automated by means of an appropriate motor activity. However, it may be sufficient here to supply a device which adjusts the inclination of the buffer paths in such a way that the bank note containers move in a self-acting manner. Further, robots or gripper arms can be provided which exchange the bank note containers between the apparatuses or insert them from the proposed apparatus into a suitable machine or remove them therefrom.

The object is also achieved by a method which is arranged for operating the system arrangement. The object is further solved by a computer program product having control commands which execute the proposed method when brought to be executed on a computer or which operate the proposed system arrangement.

According to the invention it is advantageous that the proposed apparatus and the proposed transport apparatus cooperate in such a way that they supply the system arrangement. In this connection, further apparatuses can also be provided. The proposed method is arranged to operate the system arrangement or to operate the proposed apparatus or the transport apparatus. Thus, the apparatus, the transport apparatus and the system arrangement have structural features which can be reproduced by means of the method or by which corresponding devices can be operated. Further, the apparatus and the transport apparatus are combinable, so that corresponding structural features of the apparatus are also taken into account in the transport apparatus, and vice versa that structural features in the transport apparatus are also taken into account in the apparatus. Thus, bank note containers can be exchanged between the apparatus and the transport apparatus.

Further advantageous configurations are explained in more detail with reference to the attached Figures. There are shown:

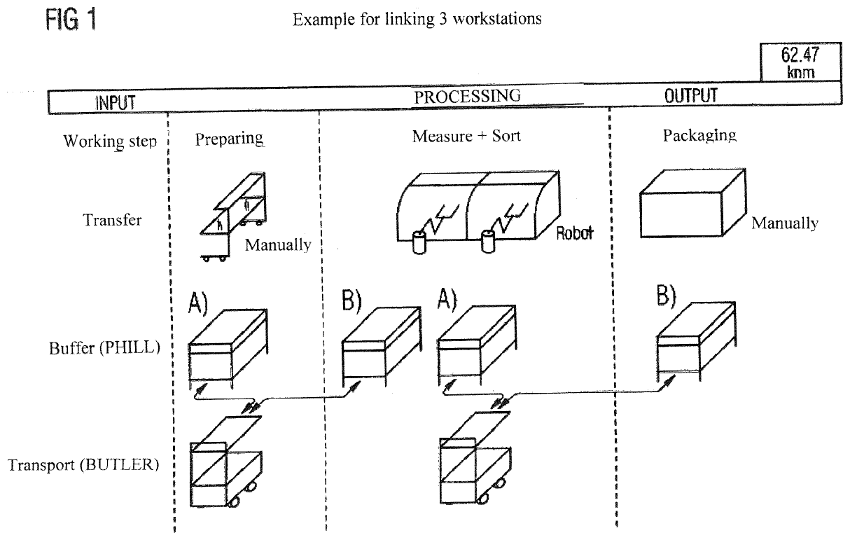

FIG. 1: an application example of the proposed system arrangement for linking three workstations according to one aspect of the present invention;

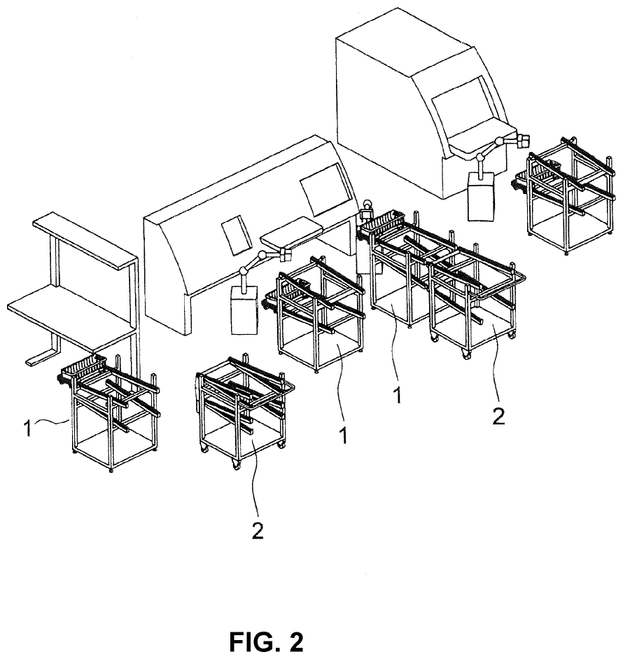

FIG. 2: a detailed application example for linking workstations according to another aspect of the present invention;

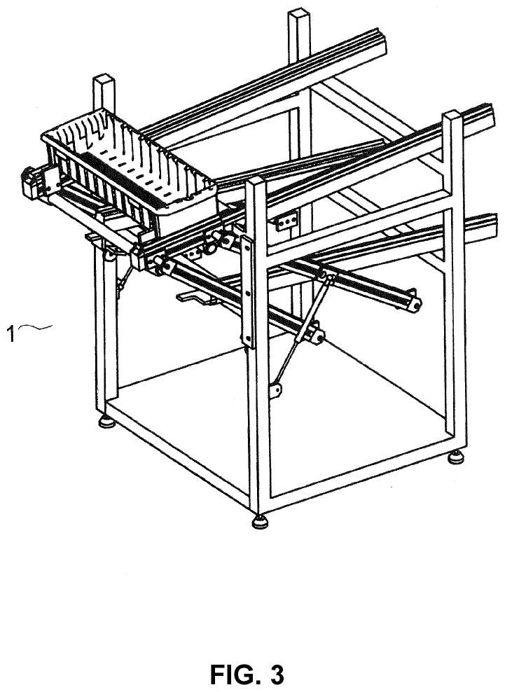

FIG. 3: the proposed apparatus for receiving, temporarily storing and dispensing bank note containers according to one aspect of the present invention;

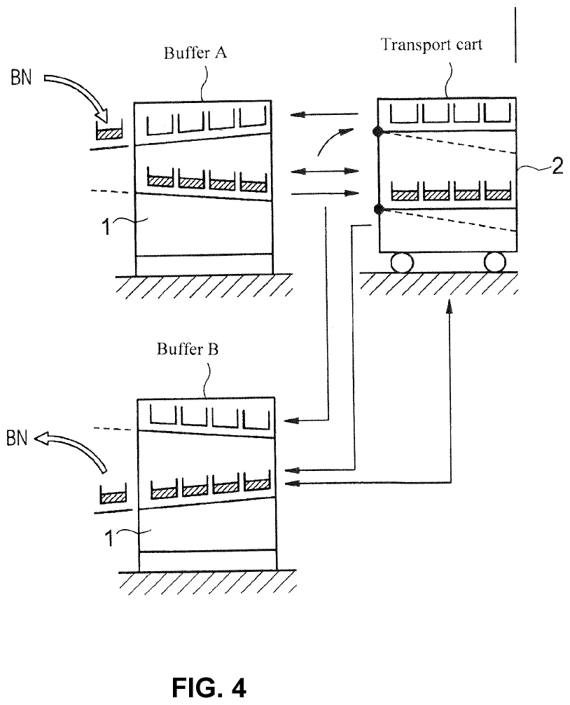

FIG. 4: an application scenario of the proposed apparatus and the proposed transport apparatus according to another aspect of the present invention;

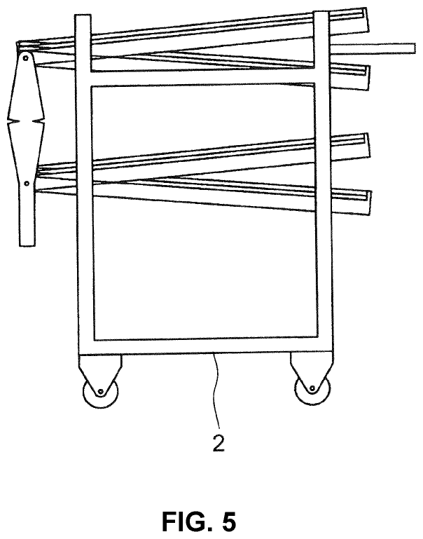

FIG. 5: the proposed transport apparatus according to one aspect of the present invention;

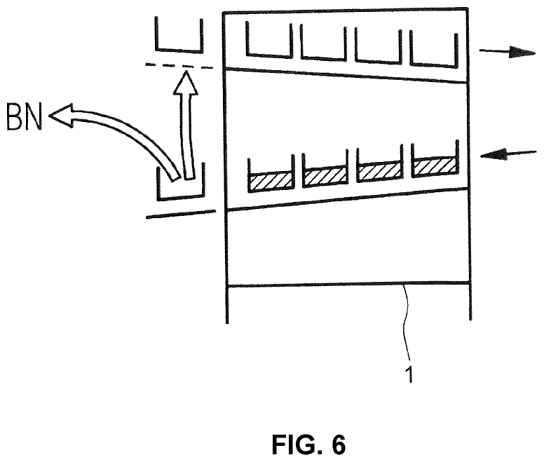

FIG. 6: the proposed apparatus as a buffer according to one aspect of the present invention;

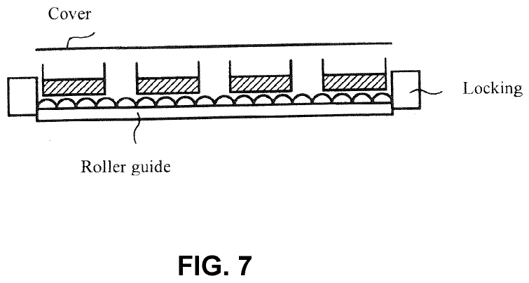

FIG. 7: a cover of a guiding path according to another aspect of the invention; and

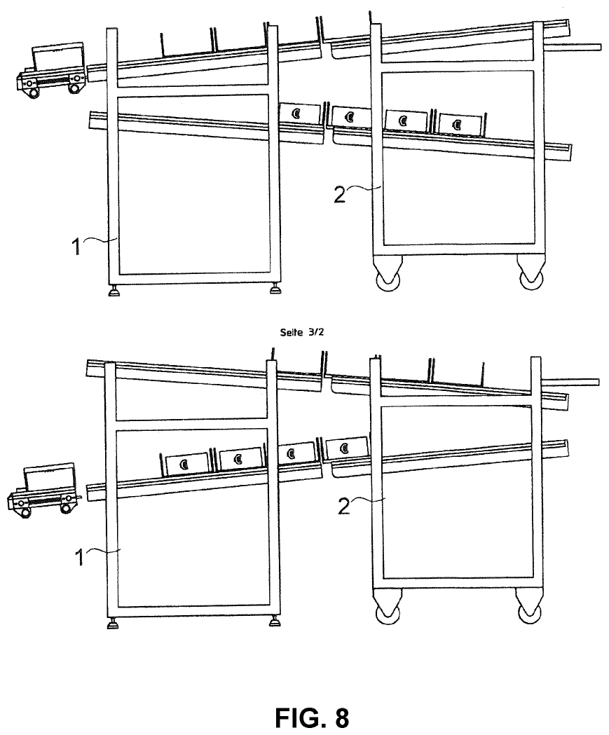

FIG. 8: the cooperation of the proposed apparatus and the proposed transport apparatus according to another aspect of the present invention.

FIG. 1 shows the system arrangement according to the invention, which shows in the center at the top a machine for measuring and sorting bank notes, to which bank note containers must be fed. For this purpose, the proposed apparatus is provided in several versions in the center of the present FIG. 1. In the present FIG. 1 at the bottom, the corresponding transport apparatus is arranged which respectively feeds bank note containers to the proposed apparatus or receives them therefrom. Further, on the top right, a machine is shown which packs bank notes, for which likewise the apparatus according to the invention is used. Thus, the apparatus for receiving, temporarily storing and dispensing bank note containers is configured as a buffer which has an effect in such a way that the machines in the upper area of FIG. 1 are always furnished with bank note containers or bank notes. While the proposed apparatus in the center of FIG. 1 is stationary with respect to location, the transport apparatus is configured with rollers in such a way that the bank note containers can be brought toward or away from the buffer.

FIG. 2 shows another application example in a similar representation, where the proposed apparatus 1 is configured with supports and the proposed transport apparatus 2 is configured with rollers. In front of the processing machines gripper arms are arranged which take bank note containers from the proposed apparatus or feed bank note containers to these. Thus at least a partial automation of the proposed system arrangement can be achieved.

FIG. 3 shows the proposed apparatus 1 having a bank note container on the left side. Here, two rails are provided, in this case arranged at the top, which form a buffer path. Underneath there are also arranged two rails, which represent a further buffer path. As apparent from the present FIG. 3, the inclination is adjusted such that the bank note containers can be taken on the left side. The lower buffer path is arranged in such a way that the bank note containers slide into the apparatus in such a way that they can be stowed inside apparatus 1.

FIG. 4 shows two apparatuses 1 according to the invention on the left and a transport apparatus 2 on the right. Here, the apparatuses act as buffers and the transport apparatus 2 is configured as a transport cart. Here, bank note containers on the transport cart are introduced into the respective buffer on the left-hand side or are taken therefrom. In the apparatus on the top left, the angle of inclination is adjusted in such a way that the bank note containers slide from right to left without the need for an additional motor. This is accomplished solely by the slope of the tiltably mounted buffer path. On the left side, the bank note container slides out of the apparatus. Likewise, it is possible to use the lower buffer path in such a way that the bank note containers slide into apparatus 1.

The apparatus and the transport apparatus 2 can interact in such a way that the buffer path is extended by means of the transport path of the transport cart and the bank note containers slide from the buffer into the transport apparatus. It is also possible for the bank note containers to slide on the other buffer path from the transport cart into the proposed apparatus on the left.

The transport cart can now be moved away from the upper buffer and docked to the lower buffer. In this way, full bank note containers can be taken from the upper buffer and added to the lower buffer.

FIG. 5 shows the proposed transport apparatus 2 which is variable with respect to location as it comprises rollers at the bottom. This transport apparatus has transport paths which correspond to the buffer paths of the buffer. Thus, a bringing in or removing of bank note containers can be accomplished on the left side, for example. Further, the tiltable positions of the respective transport path are schematically shown. These may differ by plus/minus 5 degrees, for example.

The cart can be docked to a buffer by pushing it toward it. By this movement the transport paths on the cart are swivelled. Locking pawls on the buffers are released and the containers can now roll on the inclined plane into the cart or the buffer by gravity. Upon docking, the transport paths in the buffer are locked. In the cart, always only one of the two transport paths is loaded, thus the transport paths are always inclined such that the containers are secured against unintentional rolling out. The respective angle of inclination or the first position or the second position are adjusted in such a way whether now the upper buffer path or the lower buffer path or transport path is to be served.

FIG. 6 shows the apparatus 1 according to the invention as a buffer. The bank note containers are moved on rollers onto the inclined plane by gravity. The rocker is locked at the bottom, the lock must be released after filling, which can be done manually or by means of a robot. The rocker moves upwards by spring force. The empty rocker must be moved down again manually or by robots and the like. An undesirable rolling of the bank note containers is prevented by locking pawls, for example. This is effected by means of singling the containers between the guide at the bottom and the rocker at the bottom.

FIG. 7 shows a cover of both the proposed apparatus 1 and the proposed transport apparatus. Here, a roller guide is arranged at the bottom and a locking on the left and the right side. The cover is arranged thereabove. The bank note containers can be covered on all the guide tracks, thus preventing direct access to the bank notes. Access security can be increased by mechanically locking the transfer points of the containers.

FIG. 8 shows on the left side the proposed apparatus 1 and on the right side the proposed transport apparatus 2. As can be seen from the above, the position of the buffer path is selected in such a way that the bank note containers slide out of apparatus 1 on the left side. Thus, these transport containers can be brought forward from the right side by means of transport apparatus 2 and be transferred from transport apparatus 2 to the apparatus only by means of rollers. In the lower transport path, a buffer path is coupled to the transport path of transport apparatus 2. Thus, in the lower path in the upper image, bank note containers can be inserted on the left and roll into the transport apparatus on the right.

In the lower area of the present FIG. 8, the angle of slope is represented inverse to the angle of the example above. Thus, in the lower part of FIG. 8, the bank note containers are inserted at the top left and slide into the transport apparatus 2 at the bottom right.

The opposite is true for the lower transport path of the lower part of the present FIG. 8. Here, the bank note containers can be taken on the left side. The upper illustration and the lower illustration of FIG. 8 may be the same apparatuses, where the buffer paths or transport paths can be inverted so that these can be tilted from a first position to a second position.

The bank note containers are moved on rollers onto the inclined plane by gravity. Filled containers travel downwards on a rocker by gravity. The rocker moves upward again by spring force. The rocker is locked at the top, the lock must be released after filling, which can be done manually or by means of a robot. An undesirable rolling of the containers is prevented by locking pawls. The locking pawl has the function that, if the rocker is arranged at the top, the containers can travel onto the rocker. If the rocker is in motion, the upper buffer path and the rocker are locked. If the rocker is at the bottom, the buffer path at the top is locked and the rocker is unlocked. The containers can thus roll onto the lower buffer path.

The locking pawl thus serves to lock the position of the buffer path as well as to lock the bank note containers.

Thus, a mechanical bank note container supplying system for linking workstations, for example in so-called cash centers, is proposed. According to the invention, handling and buffering a plurality of bank note containers is effected for linking workstations. Depending on the workstation, several empty bank note containers are supplied and filled bank note containers are transported away or vice versa.

Thus, according to the invention the advantage ensues that workstations can continuously work independently of each other and always hold enough bank notes in stock. When supplying bank note containers, whether full or empty, the containers no longer need to be moved manually. The transport and exchange of bank note containers always works with a plurality of bank note containers, which saves time. Further, the access security for the bank notes is guaranteed according to the invention.

1.-15. (canceled)

16. An apparatus for receiving, temporarily storing and dispensing bank note containers, comprising:
at least two buffer paths configured to be elongated and arranged for temporarily storing a plurality of bank note containers within the apparatus,
wherein the at least two buffer paths are each movable, in particular tiltable, independently of each other into a first position for receiving bank note containers and are further movable, in particular tiltable, independently of each another into a second position for dispensing bank note containers.

17. The apparatus according to claim 16, wherein the at least two buffer paths are to be filled or emptied independently of each other in such a way that at least one first buffer path is to be filled with empty bank note containers and at least one second buffer path with filled bank note containers is to be emptied.

18. The apparatus according to claim 16, wherein the buffer paths are arranged one above the other.

19. The apparatus according to claim 16, wherein the buffer paths are mounted to be movable, in particular tiltable, in such a way that by means of an arising inclination the bank note containers are movable in a self-acting manner within the apparatus by means of gravity.

20. The apparatus according to claim 16, wherein the buffer paths comprise rollers for moving the bank note containers.

21. The apparatus according to claim 16, wherein the buffer paths comprise locking pawls for locking the bank note containers and/or for locking the position of the buffer paths.

22. The apparatus according to claim 16, wherein the buffer paths are conveyable from the first position into the second position by means of spring force and/or gravity.

23. The apparatus according to claim 16, wherein the buffer paths are secured by means of a cover against unauthorized intervention.

24. The apparatus according to claim 16, wherein at least one transfer device for receiving and/or dispensing the plurality of bank note containers into and/or out of the apparatus is provided.

25. A transport apparatus for filling and/or emptying the apparatus according to claim 16, wherein the transport apparatus cooperates with the apparatus in such a way that a plurality of bank note containers are exchangeable between the transport apparatus and the apparatus.

26. A system arrangement for the mechanical supplying of a plurality of bank note containers, comprising the apparatus according to claim 16, wherein the transport apparatus cooperates with the apparatus in such a way that a plurality of bank note containers are exchangeable between the transport apparatus and the apparatus.

27. The system arrangement according to claim 26, wherein further processing machines are provided to which bank note containers are fed or from which bank note containers are taken by means of the apparatus.

28. The system arrangement according to claim 26, wherein the system arrangement is operable at least partly automatically.

29. A method arranged for operating the system arrangement of claim 26.

30. A computer program product having control commands which execute the method according to claim 29 when brought to be executed on a computer.
